(19) United States
(12) Patent Application Publication
(10) Pub. No.: US 2022/0212863 A1
(43) Pub. Date: Jul. 7, 2022

(54) Trashbag Dispensing Assembly

(71) Applicant: Kevin Gann, Pineville, KY (US)

(72) Inventor: Kevin Gann, Pineville, KY (US)

(21) Appl. No.: 17/141,575

(22) Filed: Jan. 5, 2021

(51) Int. Cl. B65F 1/06

(52) U.S. Cl. CPC B65F 1/062

(57) ABSTRACT

A trash bag dispensing assembly for storing a roll of trash bags with a garbage can includes a garbage can for receiving garbage. A plurality of engagements is each movably coupled to the garbage can. A bucket is provided and the garbage can is releasably coupled thereto such that the bucket defines a storage compartment beneath the garbage can. A trash bag dispenser is provided and the trash bag dispenser is positioned inside the bucket. Moreover, a roll of trash bags is positionable on the trash bag dispenser for storing the trash bags with the garbage can.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to dispensing devices and more particularly pertains to a new dispensing device for storing a roll of trash bags with a garbage can.

### (2) Description of Related Art Including Information Disclosed Under 37 CFR 1.97 and 1.98

The prior art relates to dispensing devices. The prior art discloses a variety of garbage cans that have a storage space integrated therein for storing a roll of trash bags. Moreover, in at least one instance the prior art discloses a dispensing unit that is removably positionable in a garbage can. In no instance does the prior art disclose a dispensing unit upon which a garbage can could be placed.

### BRIEF SUMMARY OF THE INVENTION

An embodiment of the disclosure meets the needs presented above by generally comprising a garbage can for receiving garbage. A plurality of engagements is each movably coupled to the garbage can. A bucket is provided and the garbage can is releasably coupled thereto such that the bucket defines a storage compartment beneath the garbage can. A trash bag dispenser is provided and the trash bag dispenser is positioned inside the bucket. Moreover, a roll of trash bags is positionable on the trash bag dispenser for storing the trash bags with the garbage can.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a trash bag dispensing assembly according to an embodiment of the disclosure.

FIG. 2 is an exploded perspective view of an embodiment of the disclosure.

FIG. 3 is a right side phantom view of an embodiment of the disclosure.

FIG. 4 is a top view of a bucket of an embodiment of the disclosure.

FIG. 5 is a cut away view a bucket and a membrane of an embodiment of the disclosure.

FIG. 6 is a perspective view of an embodiment of the disclosure showing a rounded garbage can and a rounded bucket.

### DETAILED DESCRIPTION OF THE INVENTION

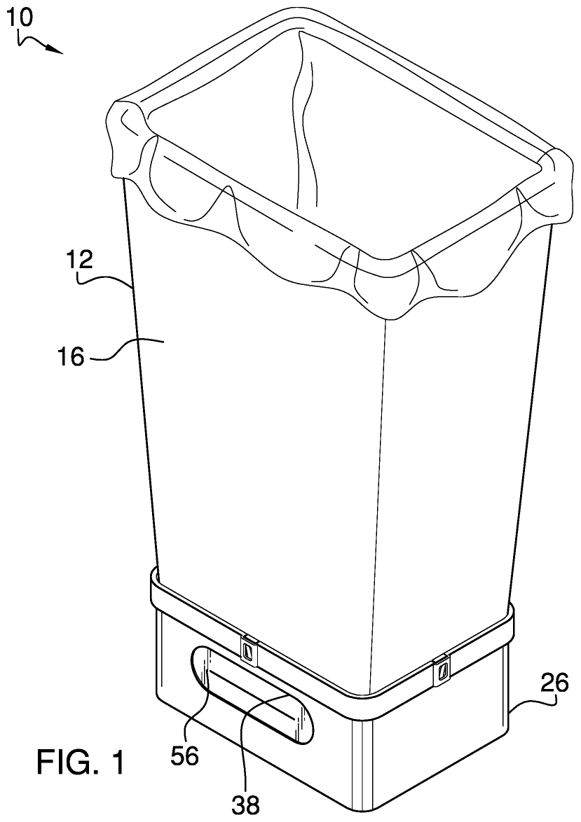

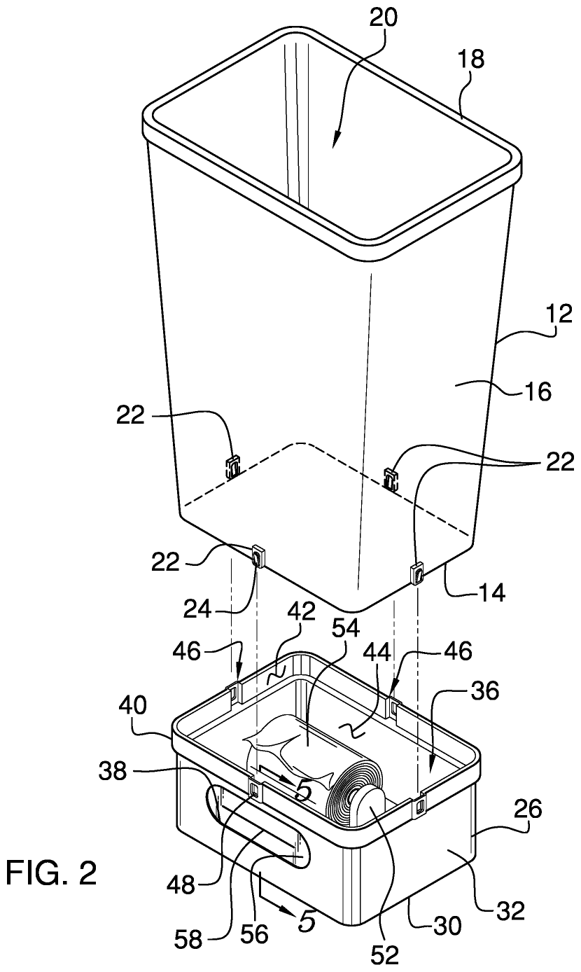

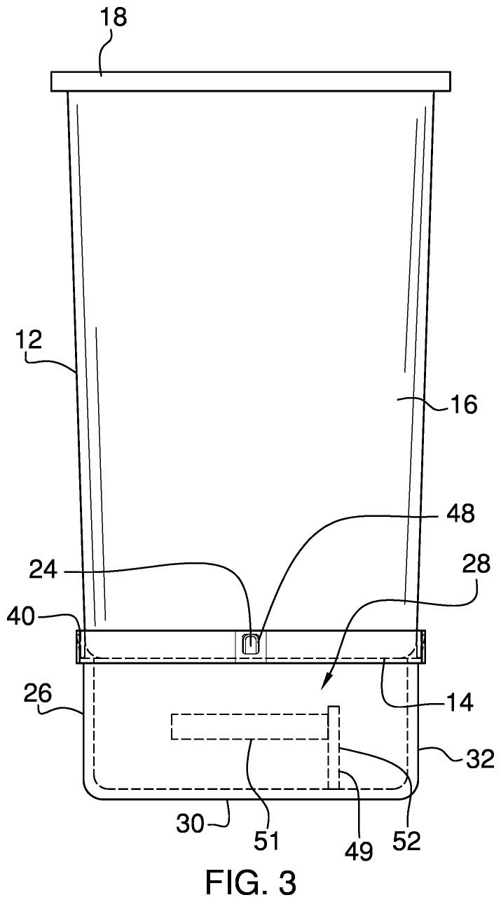

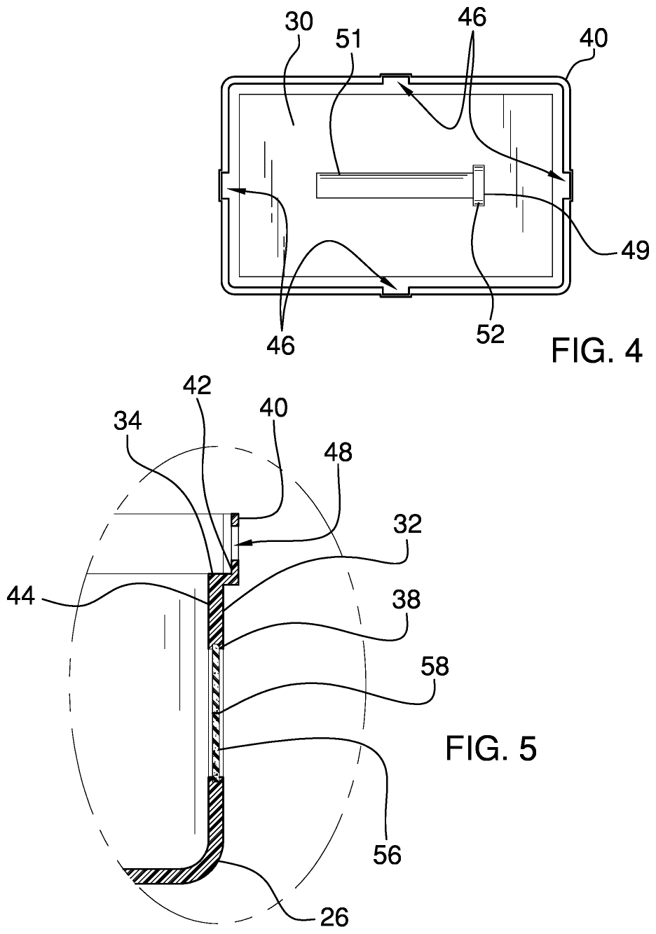

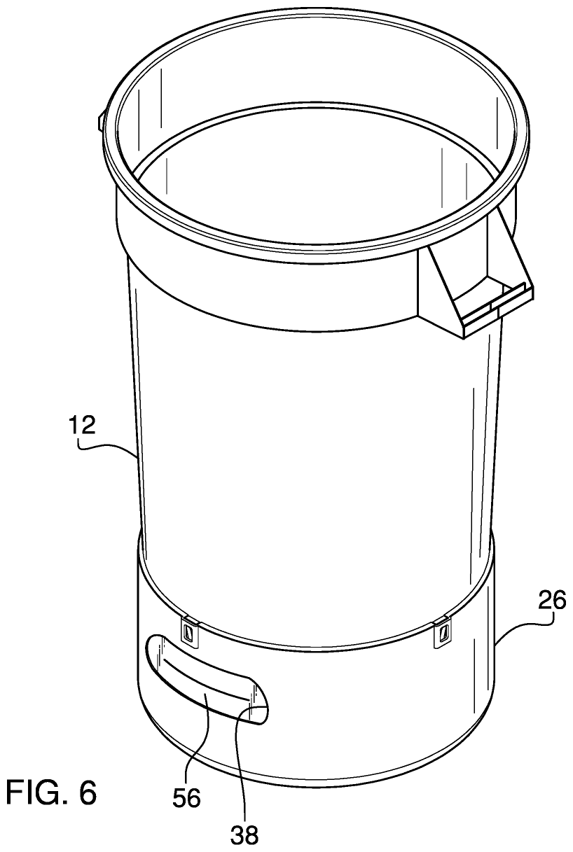

With reference now to the drawings, and in particular to FIGS. 1 through 6 thereof, a new dispensing device embodying the principles and concepts of an embodiment of the disclosure and generally designated by the reference numeral 10 will be described.

As best illustrated in FIGS. 1 through 6, the trash bag dispensing assembly 10 generally comprises a garbage can 12 for receiving garbage. The garbage can 12 has a bottom wall 14 and a perimeter wall 16 extending upwardly therefrom, and the perimeter wall 16 has a distal edge 18 with respect to the bottom wall 14 to define an opening 20 into the garbage can 12. The garbage can 12 may be a plastic kitchen garbage can, a metallic bathroom garbage can, or any other type of garbage can that would commonly be found in a home.

A plurality of engagements 22 is each movably coupled to the garbage can 12 and each of the engagements 22 is positioned on the perimeter wall 16. The plurality of engagements 22 is positioned adjacent to the bottom wall 14. Moreover, each of the engagements 22 includes a tab 24 that is biased into a locking position and that can be depressed into an unlocking position.

A bucket 26 is provided and the garbage can 12 is releasably coupled thereto such that the bucket 26 defines a storage compartment 28 beneath the garbage can 12. The bucket 26 has a lower wall 30 and an exterior wall 32 extending upwardly from a perimeter of the lower wall 30. The exterior wall 32 has a distal edge 34 with respect to the lower wall 30 to define an opening 36 into the bucket 26. Additionally, the exterior wall 32 has a dispensing opening 38 extending into an interior of the bucket 26.

A lip 40 is coupled to and extends upwardly from the distal edge 34 of the exterior wall 32, and the lip 40 is coextensive with the distal edge 34 of the exterior wall 32. The lip 40 has an inwardly facing surface 42 that is inset from an interior surface 44 of the exterior wall 32 of the bucket 26. Thus, the bottom wall 14 of the garbage can 12 rests on the distal edge 34 of the exterior wall 32 when the garbage can 12 is positioned on the bucket 26. The inwardly facing surface 42 of the lip 40 has a plurality of recesses 46 therein and each of the recesses 46 receives a respective one of the engagements 22 on the garbage can 12.

The lip 40 has a plurality of holes 48 extending therethrough and each of the holes 48 intersects a respective recess 46. The tab 24 on the respective engagements 22 extends through a respective one of the holes 48 for retaining the garbage can 12 on the bucket 26. Moreover, the tab 24 on the respective engagements 22 disengages the respective hole when the tab 24 is depressed for removing the garbage can 12 from the bucket 26.

A trash bag dispenser 52 is positioned inside the bucket 26 and a roll of trash bags 54 is positionable on the trash bag dispenser 52 for storing the trash bags with the garbage can 12. The trash bag dispenser 52 may comprise an upright 49 and a rod 51 that is oriented to extend along a line being parallel to the lower wall 30 of the bucket 26. The roll of trash bags 54 may be plastic garbage bags of any conventional design. A membrane 56 is coupled to the exterior wall 32 of the bucket 26 and the membrane 56 covers the dispensing opening 38 in the exterior wall 32. The membrane 56 has a cut 58 therein to facilitate a user to pass their hands through the membrane 56 for retrieving one of the trash bags 54 stored in the bucket 26. As is most clearly shown in FIG. 6, each of the garbage can 12 and the bucket 26 may have a rounded shape.

In use, the roll of trash bags 54 is positioned on the trash bag dispenser 52 and the garbage can 12 is positioned on top of the bucket 26. In this way the roll of trash bags 54 is stored with the garbage can 12. Each of the roll of trash bags 54 is retrievable through the dispensing opening 38 in the bucket 26 to be positioned in the garbage can 12. In this way the garbage can 12 does not have to be removed from the bucket 26 to retrieve a trash bag 54. The tab 24 on each of the engagements 22 is depressed and the garbage can 12 is lifted upwardly to remove the garbage can 12 from the bucket 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A trash bag dispensing assembly being configured to store trash bags and refuse, said assembly comprising:
a garbage can for receiving garbage, said garbage can having a bottom wall and a perimeter wall extending upwardly from said bottom wall, said perimeter wall having a distal edge with respect to said bottom wall to define an opening into said garbage can;
a plurality of engagements, each of said engagements being movably coupled to said garbage can;
a bucket having said garbage can being releasably coupled thereto such that said bucket defines a storage compartment beneath said garbage can, said bottom wall of said garbage can being continuous within said perimeter wall wherein said storage compartment is discrete from an interior of said garbage can; and
a trash bag dispenser being positioned inside said bucket, said trash bag dispenser having a roll of trash bags being positionable thereon for storing the trash bags with said garbage can.

2. The assembly according to claim 1, wherein
each of said engagements is positioned on said perimeter wall, said plurality of engagements being positioned adjacent to said bottom wall.

3. The assembly according to claim 1, wherein said bucket has a lower wall and an exterior wall extending upwardly from a perimeter of said lower wall, said exterior wall having a distal edge with respect to said lower wall to define an opening into said bucket, said exterior wall having a dispensing opening extending into an interior of said bucket, said dispensing opening being an only access into said bucket when said garbage can is engaged to said bucket.

4. The assembly according to claim 3, further comprising a lip being coupled to and extending upwardly from said distal edge of said exterior wall, said lip being coextensive with said distal edge, said lip having an inwardly facing surface being inset from an interior surface of said exterior wall of said bucket, said bottom wall of said garbage can rests on said distal edge when said garbage can is positioned on said bucket, said inwardly facing surface of said lip having a plurality of recesses therein, each of said recesses receiving a respective one of said engagements on said garbage can.

5. The assembly according to claim 4, wherein:
each of said engagements includes tab that is biased into a locking position and that can be depressed into an unlocking position; and
said lip has a plurality of holes extending therethrough, each of said holes intersecting a respective recess, said tab on said respective engagements extending through a respective one of said holes for retaining said garbage can on said bucket, said tab on said respective engagements disengaging said respective hole when said tab is depressed for removing said garbage can from said bucket.

6. The assembly according to claim 3, further comprising a membrane being coupled to said exterior wall of said bucket, said membrane covering said dispensing opening in said exterior wall, said membrane having a cut therein wherein said cut is configured to facilitate a user to pass their hands through said membrane for retrieving a garbage bag stored in said bucket.

7. A trash bag dispensing assembly being configured to store trash bags and refuse, said assembly comprising:
a garbage can for receiving garbage, said garbage can having a bottom wall and a perimeter wall extending upwardly therefrom, said perimeter wall having a distal edge with respect to said bottom wall to define an opening into said garbage can;
a plurality of engagements, each of said engagements being movably coupled to said garbage can, each of said engagements being positioned on said perimeter wall, said plurality of engagements being positioned adjacent to said bottom wall, each of said engagements including tab that is biased into a locking position and that can be depressed into an unlocking position;
a bucket having said garbage can being releasably coupled thereto such that said bucket defines a storage compartment beneath said garbage can, said bottom wall of said garbage can being continuous within said perimeter wall wherein said storage compartment is discrete from an interior of said garbage can, said bucket having a lower wall and an exterior wall extending upwardly from a perimeter of said lower wall, said exterior wall having a distal edge with respect to said lower wall to define an opening into said bucket, said exterior wall having a dispensing opening extending into an interior of said bucket, said dispensing opening being an only access into said bucket when said garbage can is engaged to said bucket;
a lip being coupled to and extending upwardly from said distal edge of said exterior wall, said lip being coextensive with said distal edge, said lip having an inwardly facing surface being inset from an interior surface of said exterior wall of said bucket, said bottom wall of said garbage can rests on said distal edge when said garbage can is positioned on said bucket, said inwardly facing surface of said lip having a plurality of recesses therein, each of said recesses receiving a respective one of said engagements on said garbage can, said lip having a plurality of holes extending therethrough, each of said holes intersecting a respective recess, said tab on said respective engagements extending through a respective one of said holes for retaining said garbage can on said bucket, said tab on said respective engagements disengaging said respective hole when said tab is depressed for removing said garbage can from said bucket;
a trash bag dispenser being positioned inside said bucket, said trash bag dispenser having a roll of trash bags being positionable thereon for storing the trash bags with said garbage can; and
a membrane being coupled to said exterior wall of said bucket, said membrane covering said dispensing opening in said exterior wall, said membrane having a cut therein wherein said cut is configured to facilitate a user to pass their hands through said membrane for retrieving a garbage bag stored in said bucket.
